(19) United States
(12) Patent Application Publication
(10) Pub. No.: US 2026/0196182 A1
(43) Pub. Date: Jul. 9, 2026

(54) DISPLAY PANEL AND DISPLAY DEVICE

(71) Applicant: SUZHOU CHINA STAR OPTOELECTRONICS TECHNOLOGY CO., LTD., Suzhou (CN)

(72) Inventor: Meng WANG, Suzhou (CN)

(73) Assignee: SUZHOU CHINA STAR OPTOELECTRONICS TECHNOLOGY CO., LTD., Suzhou (CN)

(21) Appl. No.: 19/250,201

(22) Filed: Jun. 26, 2025

(30) Foreign Application Priority Data
Jan. 8, 2025 (CN) 202510027472.4

(51) Int. Cl. G09G 3/36

(52) U.S. Cl. CPC G09G 3/3655; G09G 3/3688; G09G 2310/0245; G09G 2310/08; G09G 2320/0233; G09G 2320/0247; G09G 2320/0276; G09G 2330/021

(57) ABSTRACT

The present disclosure provides a display panel and a display device. The display panel includes a plurality of sub-pixels, a plurality of pixel circuits, and power supply lines for transmitting power signals to common electrodes. Each pixel circuit includes a capacitor. Among the plurality of pixel circuits, a capacitance value of the capacitor of a first pixel circuit and a capacitance value of the capacitor of a second pixel circuit are different. Two power signals transmitted by two power supply lines connected to the first pixel circuit and the second pixel circuit are different.

### CROSS-REFERENCE TO RELATED APPLICATION

This application claims priority to Chinese Patent Application No. 202510027472.4, filed on Jan. 8, 2025. The disclosure of the aforementioned application is incorporated herein by reference in its entirety.

### TECHNICAL FIELD

The present disclosure relates to the field of display technologies, and in particular, to a display panel and a display device.

### BACKGROUND

In order to reduce production costs, a mask splicing exposure method is generally used to prepare relatively large panels. However, in a splicing exposure process, different exposure areas are exposed through different masks or exposed in times, resulting in differences in the size of some metal layers, resulting in flickering in some areas of the panel, which affects the effect of a variable refresh rate (VRR) of an e-sports screen.

### SUMMARY

Embodiments of the present disclosure provide a display panel, a display area of the display panel includes a first display area and a second display area, and the display panel includes: a plurality of pixel electrodes including a plurality of first pixel electrodes located in the first display area and a plurality of second pixel electrodes located in the second display area; a plurality of pixel circuits corresponding to the plurality of pixel electrodes, the plurality of pixel circuits including a plurality of first pixel circuits electrically connected to the plurality of first pixel electrodes, respectively, and including a plurality of second pixel circuits electrically connected to the plurality of the second pixel electrodes, respectively, where each of the pixel circuits includes a capacitor, and a capacitance value of the capacitor of each of the first pixel circuits and a capacitance value of the capacitor of each of the second pixel circuits are different; a first power supply line configured to transmit a first power signal; and a second power supply line configured to transmit a second power signal. The plurality of first pixel circuits include a first sub-common electrode and a second sub-common electrode, the first sub-common electrode includes an area directly facing the plurality of first pixel electrodes, and the second sub-common electrode includes an area directly facing the plurality of second pixel electrodes. The first power signal transmitted by the first power supply line to the first sub-common electrode is different from the second power signal transmitted by the second power supply line to the second sub-common electrode.

Embodiments of the present disclosure also provide a display device, including: the display panel as described in any of the above; and a housing for accommodating the display panel.

### BRIEF DESCRIPTION OF THE DRAWINGS

The present disclosure will be further described below with reference to the accompanying drawings. It should be noted that the drawings in the following description are merely for explaining some embodiments of the present disclosure, and those skilled in the art can obtain other drawings based on these drawings without making creative efforts.

FIG. 1, FIG. 6, and FIG. 7 are schematic architectural diagrams of a display panel according to embodiments of the present disclosure.

FIG. 2 is a circuit diagram of a pixel circuit according to embodiments of the present disclosure.

FIG. 3 is a layout diagram of an array substrate according to embodiments of the present disclosure.

FIG. 4 is a timing diagram of some signals in a display panel according to embodiments of the present disclosure.

FIG. 5 is a schematic cross-sectional diagram of a display panel according to embodiments of the present disclosure.

FIG. 8 is a schematic plan diagram of a display device according to embodiments of the present disclosure.

### DETAILED DESCRIPTION

Hereinafter, technical solutions in the embodiments of the present disclosure will be clearly and completely described with reference to the drawings in the embodiments of the present disclosure. Obviously, the embodiments described are only some embodiments of the present disclosure, but not all embodiments. Based on the embodiments in the present disclosure, all other embodiments obtained by those skilled in the art without creative work fall within the scope of protection of the present disclosure.

In the description of the present disclosure, the terms “first,” “second,” etc. are used for descriptive purposes only, and are not to be understood as indicating or implying relative importance or as implicit indication of the number of technical features indicated. Thus, features defined as “first”, “second” may explicitly or implicitly include one or more of the features. In addition, it should be noted that the drawings only provide structures closely related to the present disclosure, and some details not related to the present disclosure are omitted, so as to simplify the drawings and make the inventive concept clear at a glance, and do not indicate that the actual apparatus is exactly the same as the drawings, and do not limit the actual apparatus.

Reference herein to an “embodiment” means that a particular feature, structure, or characteristic described in connection with the embodiment may be included in at least one embodiment of the present disclosure. The occurrence of this phrase at various locations in time in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

The present disclosure provides a display panel. The display panel includes, but is not limited to, the following embodiments and combinations of the following embodiments.

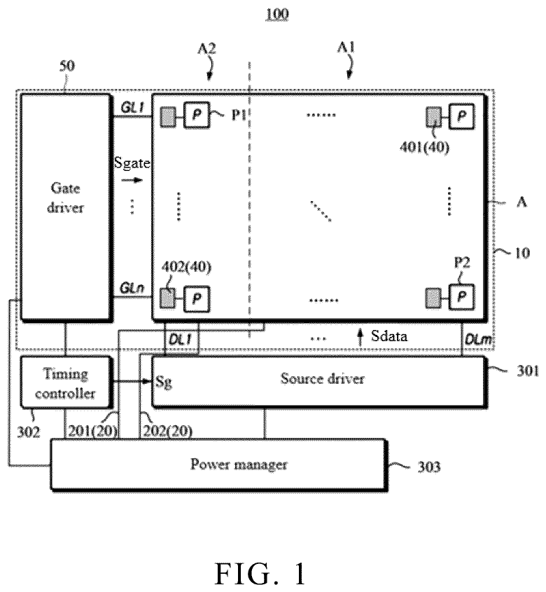

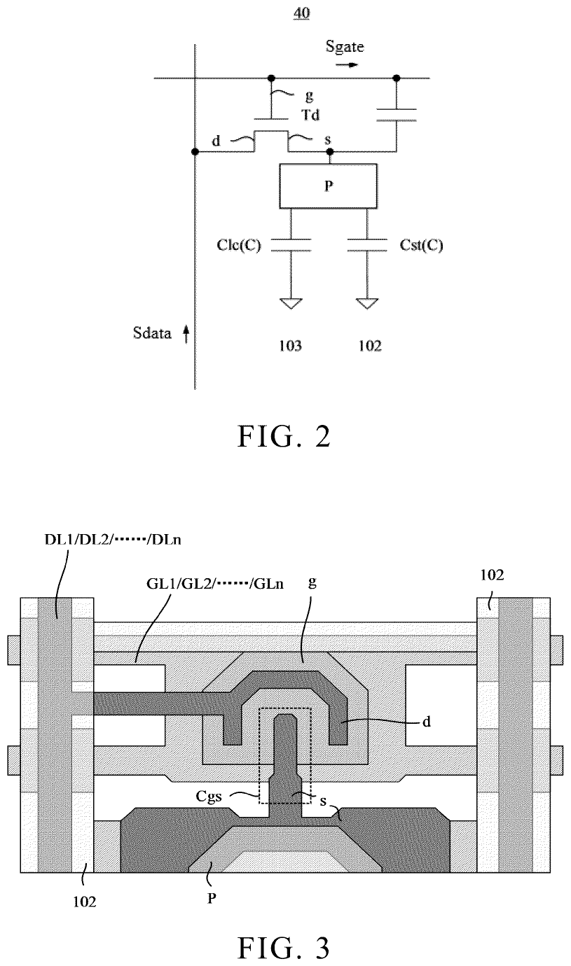

In one embodiment, as illustrated in combination with FIG. 1 to FIG. 2, a display panel 100 includes: a plurality of sub-pixels P; a plurality of pixel circuits 40 corresponding to the plurality of sub-pixels P, each of the pixel circuits 40 being electrically connected to a corresponding one of the sub-pixels P, each of the pixel circuits 40 including a corresponding capacitor C; and power supply lines 20 electrically connected to the plurality of pixel circuits 40 for transmitting power signals. The plurality of pixel circuits 40 include at least one first pixel circuit 401 and at least one second pixel circuit 402. A capacitance value of the capacitor C of the first pixel circuit 401 and a capacitance value of the capacitor C of the second pixel circuit 402 are different. The power signal (referred to as a first power signal here) transmitted by the power supply line 20 (i.e., the first power supply line 201) electrically connected to the first pixel circuit 401 is different from the power signal (referred to as a second power signal here) transmitted by the power supply line 20 (i.e., the second power supply line 202) electrically connected to the second pixel circuit 402.

The display panel 100 may be, but is not limited to, a liquid crystal display panel, an organic self-luminous display panel, or an inorganic self-luminous direct display panel. As illustrated in FIG. 1, here a plurality of sub-pixels P in a display area A of the display panel 100 are arranged in an array of n rows and m columns, where n and m are both positive integers. Correspondingly, the display panel 100 may further include a plurality of data lines (DL1 to DLm), a plurality of gate lines (GL1 to GLn), a source driver 301 electrically connected to the plurality of data lines, and a gate driver 50 electrically connected to the plurality of gata lines. The gate driver 50 may be a gate driving circuit included in an array substrate 10 of the display panel 100 or a chip provided independently of the array substrate 10 (FIG. 1 illustrates only the previous case as an example).

Specifically, each gate line (each of GL1 to GLn) is electrically connected to a plurality of pixel circuits 40 corresponding to a plurality of sub-pixels P located in a corresponding row to output a corresponding gate signal Sgate thereto. In each frame, the gate signal Sgate includes a gate pulse for controlling the corresponding plurality of pixel circuits 40 to be turned on. A plurality of rows of pixel circuits 40 are turned on sequentially under the control of a plurality of gate pulses of the plurality of gate signals. Each data line (each of DL1 to DLm) is connected to a plurality of pixel circuits 40 corresponding to a plurality of sub-pixels P located in a corresponding column to output a corresponding data signal Sdata thereto. The plurality of data signals corresponding to the plurality of columns of sub-pixels P are set so that when each row of pixel circuits 40 is turned on, the plurality of data signals Sdata also transmit a plurality of data voltages Vdata corresponding to the row of sub-pixels P, and then when each row of pixel circuits 40 is turned on, the plurality of sub-pixels P in the row are driven by the corresponding plurality of data voltages Vdata to emit light. As such, finally the plurality of rows of sub-pixels P emit light to display an image of the frame.

Furthermore, the display panel 100 may further include a timing controller 302 and a power manager 303. The timing controller 302 is electrically connected to the source driver 301 and the gate driver 50, and the power manager 303 is electrically connected to the source driver 301, the gate driver 50, the timing controller 302, and the plurality of pixel circuits 40. The plurality of pixel circuits 40 are electrically connected to the power manager 303 through the plurality of power supply lines 20. The power manager 303 can supply power to the entire display panel 100. The timing controller 302 can generate a grayscale signal Sg and a corresponding first control signal acting on the source driver 301, and can also generate a corresponding second control signal acting on the gate driver 50. Then, the source driver 301 can generate the above-mentioned plurality of data signals Sdata according to the grayscale signal Sg and the first control signal, and the gate driver 50 can generate the above-mentioned plurality of gate signals Sgate according to the second control signal.

In combination with the above discussion, each of the pixel circuits 40 is controlled by a corresponding one of the gate signals Sgate to be turned on, and controls the corresponding sub-pixels P to emit light according to the corresponding data voltage Vdata of the data signal Sdata. However, when a potential of the gate signal Sgate or a potential of other signals of acting on the pixel circuit 40 jumps, since each pixel circuit 40 includes the corresponding capacitor C, if no interference is applied, a coupling function of the capacitor C causes a potential of a signal of a node applied with the data voltage Vdata in the pixel circuit 40 to jump accordingly, resulting in the brightness of light emitted by the corresponding sub-pixels P also changes, and a flicker phenomenon is exhibited. In this regard, the global brightness can be uniformly improved by uniformly compensating the data voltages Vdata and the power signals in the global display area A.

It should be noted that the capacitance values of the capacitors C of different pixel circuits 40 may be different due to factors such as manufacturing processes, so for different pixel circuits 40, even if the potentials of the gate signals Sgate or the potentials of signals with other functions jump in the same way and other influencing factors are the same, the jumping amount of the potentials of the signals of the nodes applied with the data voltages Vdata in the pixel circuits 40 is different. Therefore, even if the data voltages Vdata and the power signals in the global display area A are uniformly compensated to uniformly improve the global brightness, at least one of two sub-pixels P corresponding to the capacitors C having a difference in the capacitance values still flickers.

It can be understood that the present embodiment considers that the power signals acting on the pixel circuits 40 also affect the brightness of the corresponding sub-pixels P, and based on the difference in the capacitance value of the capacitance C of the first pixel circuit 401 and the capacitance value of the capacitance C of the second pixel circuit 402, the power signal transmitted by the first power supply line 201 electrically connected to the first pixel circuit 401 and the power signal transmitted by the second power supply line 202 electrically connected to the second pixel circuit 402 are set to be different, so as to compensate the difference in the jumping amounts of the potentials of the signals of the nodes applied with the data voltages Vdata in the first pixel circuit 401 and the second pixel circuit 402, thereby alleviating the flicker phenomenon of the sub-pixels P corresponding to the first pixel circuit 401 or the second pixel circuit 402 when displaying an image.

In some embodiments, as illustrated in FIG. 1 to FIG. 2, the display area A of the display panel 100 includes a first display area A1 and a second display area A2. The plurality of sub-pixels P in the first display area A1 are electrically connected to a plurality of first pixel circuits 401, and the plurality of sub-pixels P in the second display area A2 are electrically connected to a plurality of second pixel circuits 402. That is, the capacitance value of the capacitor C of the pixel circuit 40 in both the first display area A1 and the second display area A2 here is different.

Specifically, for the display panel 100 prepared by a mask splicing exposure method, since different exposure areas are exposed by different masks or exposed in times, different areas in which the capacitors C having different capacitance values are located may be formed in the display panel 100. It can be considered that the plurality of first pixel circuits 401 are continuously arranged for forming the continuous first display area A1, and the plurality of second pixel circuits 402 are continuously arranged for forming the continuous second display area A2.

It can be understood that in this embodiment, for the display panel 100 prepared by the mask splicing exposure method, the power signal transmitted to the first pixel circuit 401 in the first display area A1 and the power signal transmitted to the second pixel circuit 402 in the second display area A2 are set to be different, so that the flickering phenomenon of at least a part of the display panel 100 caused by the mask splicing exposure method can be alleviated.

In some embodiments, as illustrated in combination with FIG. 1 to FIG. 3, each of the sub-pixels P includes a pixel electrode, each of the pixel circuits 40 includes a driving transistor Td, and one of a source s and a drain d of the driving transistor Td (the former is taken as an example here) is electrically connected to the corresponding pixel electrode. The capacitor C includes a first capacitor Cgs, a first plate of the first capacitor Cgs is the one of the source s and the drain d of the driving transistor Td, and a second plate of the first capacitor Cgs is a gate g of the driving transistor Td. An area of the one of the source s and the drain d of the driving transistor Td directly facing the gate g of the driving transistor Td in the first pixel circuit 401 is different from an area of the one of the source s and the drain d of the driving transistor Td directly facing the gate g of the driving transistor Td in the second pixel circuit 402. That is, that the display panel 100 is a liquid crystal display panel is taken as an example.

Here, as illustrated in FIG. 3, the driving transistor Td may be provided in the same layer as the plurality of gate lines (GL1 to GLn) and the plurality of data lines (DL1 to DLm). The gate g of the driving transistor Td may be electrically connected to the corresponding gate line, the one of the source s and the drain d of the driving transistor Td (the former here is taken as an example) may be electrically connected to the corresponding pixel electrode, and the other one of the source s and the drain d of the driving transistor Td (here, the latter is taken as an example) is electrically connected to the corresponding data line.

It can be seen from the above discussion, the plurality of rows of driving transistors Td corresponding to the plurality of rows of pixel electrodes are turned on under actions of the plurality of gate signals Sgate in sequence. When each row of driving transistors Td is turned on, the plurality of data signals Sdata also transmit the plurality of data voltages Vdata corresponding to the plurality of pixel electrodes in this row, and thus the pixel electrodes in this row are loaded with the corresponding plurality of data voltages Vdata. A plurality of liquid crystal molecules corresponding to each pixel electrode are deflected under an action of a pressure difference between this pixel electrode and a common electrode (second common electrode 103 in the subsequent section) by a corresponding angle to cause the light emitted by a backlight module to transmit the corresponding amount, and the transmitted light is combined with a corresponding color filter to present the corresponding light. By analogy, finally the liquid crystal molecules corresponding to the plurality of pixel electrodes are deflected to make the display panel 100 display one frame of image.

Combined with FIG. 1 to FIG. 4, in order to ensure that the driving transistor Td can be sufficiently turned on, a starting time of the gate pulse of the gate signal Sgate may be earlier than a starting time of the corresponding data voltage Vdata of the data signal Sdata. In order to ensure that the data voltage Vdata can be sufficiently written, an ending time of the corresponding data voltage Vdata of the data signal Sdata may be later than an ending time of the gate pulse. At a falling edge of the gate pulse, through a coupling function of the first capacitor Cgs between the source s and the gate g of the driving transistor Td, a potential of a signal Sdata′ of a node of the pixel circuit 40 applied with the data voltage Vdata also jumps accordingly, so that a flicker phenomenon occurs.

It should be noted that due to factors such as manufacturing process (including but not limited to the above-described mask splicing exposure method), the area of the one of the source s and drain d of the driving transistor Td directly facing the gate g of the driving transistor Td may be different in different areas of the display panel 100, which causes the first capacitors Cgs in different areas to have different capacitance values. After the flicker phenomenon of one of the first display area A1 and the second display area A2 is ameliorated by global compensation, the flicker phenomenon of the other still exists.

Furthermore, as illustrated in FIG. 1 to FIG. 5, the pixel circuits 40 further include: a first common electrode 102 provided in the same layer as the plurality of pixel electrodes (i.e., the sub-pixels P); and a second common electrode 103 disposed opposite to the plurality of pixel electrodes and the first common electrode 102. The capacitor C further includes a second capacitor Cst and a third capacitor Clc. A first plate of the second capacitor Cst and a first plate of the third capacitor Clc both include the pixel electrodes (i.e., the sub-pixels P), a second plate of the second capacitor Cst is the first common electrode 102, and a second plate of the third capacitor Clc is the second common electrode 103. An area of the pixel electrode corresponding to the first pixel circuit 401 directly facing the first common electrode 102 is different from an area of the pixel electrode corresponding to the second pixel circuit 402 directly facing the first common electrode 102; and/or an area of the pixel electrode corresponding to the first pixel circuit 401 directly facing the second common electrode 103 is different from an area of the pixel electrode corresponding to the second pixel circuit 402 directly facing the second common electrode 103.

Specifically, since the power supply lines 20 also transmits corresponding power signals to the first common electrode 102 and the second common electrode 103, respectively, one corresponding second capacitor Cst may be formed between the first common electrode 102 and each pixel electrode, and one corresponding third capacitor Clc may be formed between the second common electrode 103 and each pixel electrode. Similarly, due to factors such as manufacturing process (including but not limited to the above-described mask splicing exposure method), there may be differences in areas of the pixel electrodes in different areas of the display panel 100 that are directly facing at least one of the first common electrode 102 and the second common electrode 103. Similarly, after the flickering phenomenon of one of the first display area A1 and the second display area A2 has been ameliorated by the global compensation, the flicker phenomenon of the other still exists.

When coupling functions of the first capacitor Cgs, the second capacitor Cst, and the third capacitor Clc are taken into account at the same time, at the falling edge of the gate pulse, the jumping amount ΔV corresponding to the potential of the signal Sdata′ of the node applied with the data voltage Vdata in the pixel circuit 40 is (Vgh−Vgl)×Cgs0/(Cgs0+Clc0+Cst0), where Cgs0, Cst0, and Clc0 are capacitance values of the first capacitor Cgs, the second capacitor Cst, and the third capacitor Clc, respectively.

It can be seen that the capacitance value of any one of the above three capacitors is different in different areas due to factors such as manufacturing process (including but not limited to the above-mentioned mask splicing exposure method), which will cause at least one area to flicker when displaying the image.

Of course, when the display panel 100 is a self-luminous display panel, unlike the discussion above with respect to FIG. 2 and FIG. 3, each pixel circuit 40 at this time includes at least two transistors and one capacitor, and each sub-pixel P is a self-luminous element, but at this time, the capacitance value of at least one capacitor of the pixel circuit 40 in different areas is still different due to factors such as manufacturing process (including but not limited to the above-described mask splicing exposure method), which then causes the jumping amount of the potential of the signal of the node applied with the data voltage Vdata in the pixel circuit 40 to be different, so that the self-luminous element in at least one area still has a flicker phenomenon when emitting light.

In some embodiments, as illustrated in FIG. 1 to FIG. 5, each sub-pixel P includes the above-described pixel electrode. The plurality of pixel electrodes include a plurality of first pixel electrodes corresponding to the plurality of first pixel circuits 401 (the corresponding sub-pixels P are first sub-pixels P1) and a plurality of second pixel electrodes corresponding to the plurality of second pixel circuits 402 (the corresponding sub-pixels P are second sub-pixels P2). The pixel circuits 40 include: a first sub-common electrode 1031 (included in the second common electrode 103 described above) provided opposite to the plurality of first pixel electrodes (that is, the first sub-pixels P1) and electrically connected to a first sub-common voltage line (for example, the first power supply line 201 described above) of the power supply lines 20; and a second sub-common electrode 1032 (included in the second common electrode 103 described above) provided opposite to the plurality of second pixel electrodes (that is, the second sub-pixels P2) and electrically connected to a second sub-common voltage line (for example, the second power supply line 202 described above) of the power supply lines 20. A first sub-common signal CFVCOM1 transmitted by the first sub-common voltage line and a second sub-common signal CFVCOM2 transmitted by the second sub-common voltage line are different.

It can be seen from the above discussion, a number of the first common electrodes 102 may be multiple, and one corresponding second capacitor Cst may be formed between each pixel electrode and the nearest first common electrode 102 (the corresponding first common voltage is loaded through the power supply line 20) for storing the data voltage Vdata. The second common electrodes 103 (the corresponding second common voltage is loaded through the power supply line 20) may be provided as a whole layer or the number thereof is also multiple (respectively provided opposite to the plurality of pixel electrodes), so as to store the data voltage Vdata and form a corresponding pressure difference with each pixel electrode to drive the deflection of the plurality of liquid crystal molecules in the corresponding area, so that the area of the display panel 100 exhibits a corresponding brightness.

Furthermore, the first sub-common electrode 1031 and the second sub-common electrode 1032 may be provided separately to reduce the influence of the first sub-common signal CFVCOM1 and the second sub-common signal CFVCOM2 on each other.

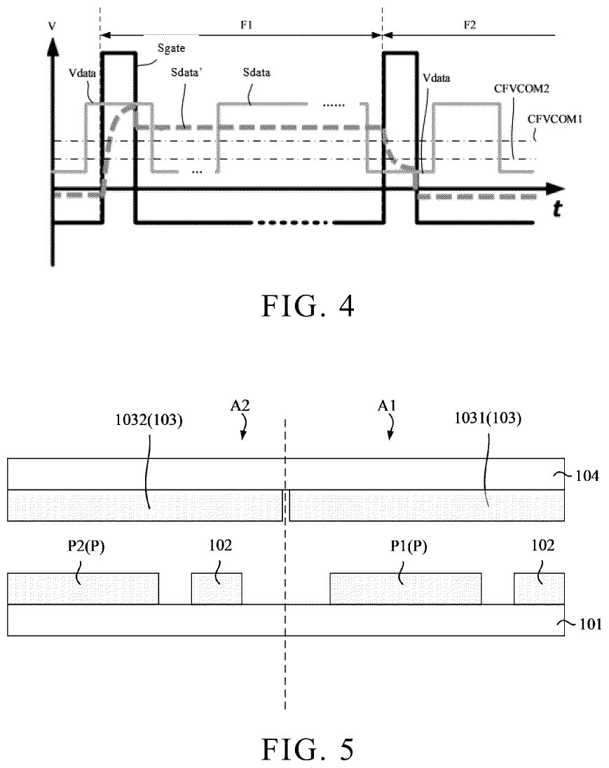

Based on the above discussion with respect to FIG. 4, furthermore, in order to avoid the liquid crystal molecules being deflected in the same direction for a long time, a polarity of the data voltage Vdata corresponding to each sub-pixel P in two adjacent frames is generally set to be opposite with respect to the second common voltage. It is illustrated here by an example that the first display area A1 is no longer flickering after the improvement of global flickering, that is, it is considered that absolute values of the differences between the data voltages Vdata of the two polarities of the sub-pixel P of the same color and the first sub-common signal CFVCOM1 under the same grayscale value are the same.

That is, if the second display area A is not interfered, there is still a flicker problem. Specifically, when the first sub-common signal CFVCOM1 is also applied to the first sub-common electrode 1031, the difference between the signal Sdata′ of the node applied with the data voltage Vdata in the pixel circuit 40 after jumping and the first sub-common signal CFVCOM1 becomes smaller in the case of a positive polarity in a current frame F1, but the difference between the signal Sdata′ of the node applied with the data voltage Vdata in the pixel circuit 40 after jumping and the first sub-common signal CFVCOM1 becomes larger in the case of a negative polarity in a next frame F2, causing the differential pressure used to drive the liquid crystal molecules to change from a larger differential pressure in the current frame to a smaller differential pressure in the next frame, thereby causing a flickering phenomenon.

Therefore, in this embodiment, for the first pixel circuit 401 and the second pixel circuit 402 including capacitors C having different capacitance values, the second sub-common signal CFVCOM2 acting on the second pixel circuit 402 is set to be different from the first sub-common signal CFVCOM1 acting on the first pixel circuit 401. For example, in FIG. 4, when the gate pulse is a positive pulse, since a jumping direction of the signal Sdata′ of the node of the pixel circuit 40 applied with the data voltage Vdata is negative, an amplitude value of the second sub-common signal CFVCOM2 can be less than an amplitude value of the first sub-common signal CFVCOM1, so that a difference between the amplitude value of the second sub-common signal CFVCOM2 and an amplitude of the positive polarity of the signal Sdata′ of the node of the pixel circuit 40 applied with the data voltage Vdata after jumping and a difference between the amplitude value of the second sub-common signal CFVCOM2 and an amplitude of the negative polarity of the signal Sdata′ of the node of the pixel circuit 40 applied with the data voltage Vdata after jumping are close, thereby alleviating the flicker phenomenon of the second display area A2.

Of course, when the gate pulse is a negative pulse, the amplitude of the second sub-common signal CFVCOM2 may be greater than the amplitude of the first sub-common signal CFVCOM1.

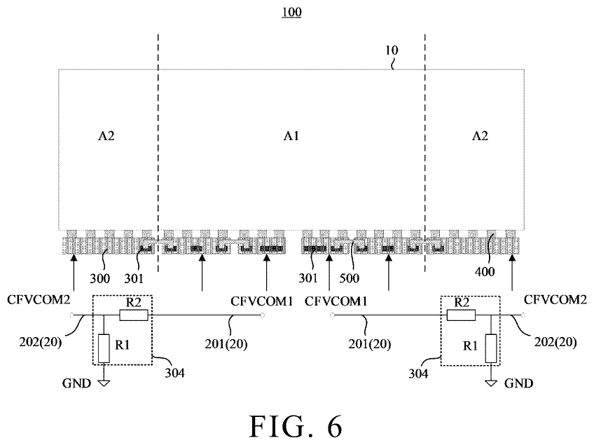

It should be noted that, when the first sub-common electrode 1031 and the second sub-common electrode 1032 are both included in the second common electrode 103, that is, the liquid crystal molecules work in a vertical electric field, it can be assumed that the liquid crystal display panel operates in a vertical alignment (VA) mode. However, if the liquid crystal display panel operates in an in-plane switching (IPS) mode, that is, the liquid crystal molecules work in a vertical electric field, then at this time, unlike shown in FIG. 5, the first sub-common electrode 1031 and the second sub-common electrode 1032 are both included in the first common electrode 102, and potentials of the second common electrode 103 in both the first display area A1 and the second display area A2 may be equal.

Furthermore, when the liquid crystal display panel operates in the VA mode and when the liquid crystal molecules are alternately operated at a positive voltage and a negative voltage (i.e., potentials of the plurality of pixel electrodes alternate between being greater than the potentials of the first sub-common electrode 1031 and the second sub-common electrode 1032 and being less than the potentials of the first sub-common electrode 1031 and the second sub-common-electrode 1032 in the plurality of frames), on the basis of setting the potential of the second common electrode 103 differentially in the first display area A1 and the second display area A2, the power supply line alternately transmits a third power signal and a fourth power signal with different amplitudes to the first common electrode 102 in the plurality of frames, so as to compensate for leakage differences of the plurality of pixel circuits 40 working under the positive voltage and the negative voltage.

In some embodiments, as illustrated in conjunction with FIG. 1 to FIG. 6, the display panel 100 further includes: the above power manager 303 connected to the first sub-common voltage line (for example, the first power supply line 201) and configured to generate the first sub-common signal CFVCOM1 (for example, the first power signal) to be output to the first sub-common voltage line; and a signal processing circuit 304 connected between the power manager 303 and the second sub-common voltage line (for example, the second power supply line 202 described above), and configured to generate the second sub-common signal CFVCOM2 (for example, the second power signal described above) to be output to the second sub-common voltage line according to the first sub-common signal CFVCOM1.

A circuit board 300 for carrying the source driver 301 may be electrically connected to the array substrate 10 by a flip chip film 400, and the source drivers 301 located on different circuit boards 300 may be connected by conductive connecting lines 500.

It can be understood the case where the amplitude of the second sub-common signal CFVCOM2 is less than the amplitude of the first sub-common signal CFVCOM1 is taken as an example. In this embodiment, by providing the signal processing circuit 304 electrically connected between the power manager 303 and the display panel 100, the first sub-common signal CFVCOM1 generated by the power manager 303 is processed to generate the second sub-common signal CFVCOM2 acting on the second sub-common electrode 1032, thereby realizing that the first sub-common electrode 1031 and the second sub-common electrode 1032 are acted on by the first sub-common signal CFVCOM1 and the second sub-common signal CFVCOM2, respectively.

Specifically, as illustrated in FIG. 6, the signal processing circuit 304 may include a first resistor R1 and a second resistor R2 connected in series. One end of the first resistor R1 is grounded to GND, and the other end of the first resistor R1 is connected to the second sub-common voltage line. One end of the second resistor R2 is connected to the power manager 303 and the first sub-common voltage line, and the other end of the second resistor R2 is connected to the second sub-common voltage line. That is, the voltage is divided by the first resistor R1 and the second resistor R2 in series to generate the second sub-common signal CFVCOM2 with the amplitude that is less than the amplitude of the first sub-common signal CFVCOM1.

Furthermore, when a size of the first display area A1 is relative large, in order to avoid a large attenuation of the first sub-common signal CFVCOM1 due to a large impedance of the first sub-common electrode 1031, the first sub-common voltage line (for example, the above-described first power supply line 201) may be set to a plurality of lines (two lines are described as examples in FIG. 6).

It should be noted that, the present embodiment in which the signal processing circuit 304 is provided independently of the power manager 303 is taken as an example, the power manager 303 may actually function as the signal processing circuit 304.

In some embodiments, as illustrated in FIG. 1 to FIG. 4 and FIG. 7, the plurality of sub-pixels P include a plurality of first-color sub-pixels (not shown) with the same color, and the display panel 100 further includes: the above plurality of data lines (DL1 to DLm). Each of the data lines is electrically connected to a corresponding plurality of the pixel circuits 40 for transmitting the plurality of data signals Sdata. The plurality of data signals Sdata include the plurality of data voltages Vdata corresponding to the plurality of sub-pixels P. When grayscale values of two first-color sub-pixels corresponding to the first pixel circuit 401 and the second pixel circuit 402 are the same at the same refresh rate, the two data voltages Vdata corresponding to the two data signal Sdata corresponding to the two first-color sub-pixels are different.

As can be seen in conjunction with the above discussion, it can be seen that in the pixel circuit 40 of the liquid crystal display panel or the self-luminous display panel, the brightness exhibited by the sub-pixel P is related to the data voltage Vdata. Therefore, in this embodiment, when there is flicker in the second display area A2, on a condition that factors such as the refresh rate, the color corresponding to the sub-pixel P, and the grayscale value of the sub-pixel P are all the same, the data voltage Vdata acting on the second display area A2 is set to be different from the data voltage Vdata acting on the first display area A1, so that the difference between the capacitance value of the capacitor C in the second display area A2 and the capacitance value of the capacitor C in the first display area A1 is compensated, and the flicker phenomenon of the second display area A2 with respect to the first display area A1 is alleviated.

In some embodiments, as illustrated in conjunction with FIG. 1 to FIG. 4 and FIG. 7, the display panel 100 further includes: a gamma circuit 305 configured to generate a first gamma binding point voltage Gamma1 and a second gamma binding point voltage Gamma 2; and the above source driver 301 electrically connected to the gamma circuit 305, configured to generate the data signal Sdata as a first data signal Sdata1 based on the grayscale signal Sg and the first gamma binding point voltage Gamma1, and further configured to generate the data signal Sdata as a second data signal Sdata2 based on the grayscale signal Sg and the second gamma binding point voltage Gamma2. The data line electrically connected to the first pixel circuit 401 is configured to transmit the first data signal Sdata1, and the data line electrically connected to the second pixel circuit 402 is configured to transmit the second data signal Sdata2.

Specifically, the gamma circuit 305 may generate at least a first gamma binding point voltage Gamma1 and a second gamma binding point voltage Gamma2 corresponding to the first-color sub-pixel according to the power supply voltage supplied by the power supply manager 303. Each of the first gamma binding point voltage Gamma1 and the second gamma binding point voltage Gamma2 may include a plurality of binding point voltages. The source driver 301 may generate a first data voltage Vdata1 and a second data voltage Vata2 having different amplitudes based on the first gamma binding point voltage Gamma1 and the second gamma binding point voltage Gamma2 at the same grayscale value at the same refresh rate, so that the first data signal Sdata1 output by the data line connected to the first pixel circuit 401 and the second data signal Sdata2 output by the data line connected to the second pixel circuit 402 are also different.

It should be noted that, in this embodiment, that the gamma circuit 305 is provided independently of the source driver 301 is taken as an example, and actually, the source driver 301 may also have the function of the gamma circuit 305.

Furthermore, as illustrated in FIG. 1 to FIG. 4 and FIG. 7, the first gamma binding point voltage Gamma1 includes a first sub-gamma binding point voltage Gamma1a and a second sub-gamma binding point voltage Gamma1b, and the second gamma binding point voltage Gamma2 includes a third sub-gamma binding point voltage Gamma2a and a fourth sub-gamma binding point voltage Gamma2b. At a first refresh rate f1, the source driver 301 is configured to generate the first data signal Sdata1 according to the grayscale signal Sg and the first sub-gamma binding point voltage Gamma 1a, and further configured to generate the second data signal Sdata2 according to the grayscale signal Sg and the third sub-gamma binding point voltage Gamma2a. At a second refresh rate f2, the source driver 301 is configured to generate the first data signal Sdata1 according to the grayscale signal Sg and the second sub-gamma binding point voltage Gamma1b, and is further configured to generate the second data signal Sdata2 according to the grayscale signal Sg and the fourth sub-gamma binding point voltage Gamma2b.

That is, in this embodiment, the first gamma binding point voltage Gamma1 and the second gamma binding point voltage Gamma2 are refined from a dimension of the refresh rate, on the condition that factors such as the color corresponding to the sub-pixel P and the grayscale value of the sub-pixel P are the same, the first gamma binding point voltage Gamma1 acting on the first display area A1 and the second gamma binding point voltage Gamma2 acting on the second display area A2 are both further refined to include a plurality of corresponding sub-gamma binding point voltages according to the difference in refresh rate. Similarly, each sub-gamma binding point voltage still includes a plurality of binding point voltages.

Of course, as illustrated in FIG. 6, the first gamma binding point voltage Gamma1 may further include a fifth sub-gamma binding point voltage Gamma1c corresponding to a third refresh rate f3, and the second gamma binding point voltage Gamma2 may further include a sixth sub-gamma binding point voltage Gamma1c corresponding to the third refresh rate f3. The first refresh rate f1, the second refresh rate f2, and the third refresh rate f3 may be, but are not limited to, 60 HZ, 120 HZ, and 240 HZ, respectively.

It can be understood that in the present embodiment, by setting the gamma binding point voltages of different areas differently according to the difference in refresh rate, it is necessary to consider the area difference and the refresh rate difference at the same time in the process of generating the data signals Sdata, and the problem of image flickering caused by the area difference and the refresh rate difference can be simultaneously alleviated.

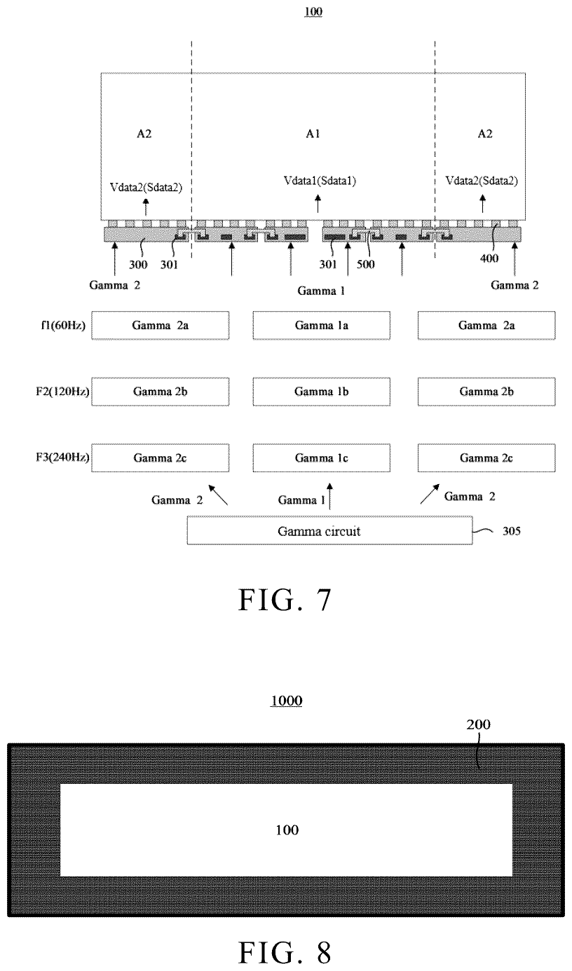

The present disclosure provides a display device, as illustrated in FIG. 8, the display device 1000 includes: the display panel 100 as described in any of the above; and a housing 200 for accommodating the display panel 100. Here, the housing 200 may cover a non-display area around the display area A of the display panel 100.

The display panel and the display device provided by the embodiments of the present disclosure have been described in detail above, and the principles and embodiments of the present disclosure have been described herein by applying specific examples, and the description of the above embodiments is only for helping to understand the technical solutions and core ideas of the present disclosure; One of ordinary skill in the art will understand that: the technical solutions described in the above-described embodiments may still be modified, or some technical features may be equivalently replaced. However, these modifications or substitutions do not cause the essence of the corresponding technical solutions to deviate from the scope of the technical solutions of each embodiment of the present disclosure.

What is claimed is:

1. A display panel, a display area of the display panel comprising a first display area and a second display area, and the display panel comprising:
a plurality of pixel electrodes comprising a plurality of first pixel electrodes located in the first display area and a plurality of second pixel electrodes located in the second display area;
a plurality of pixel circuits corresponding to the plurality of pixel electrodes, wherein the plurality of pixel circuits comprise a plurality of first pixel circuits electrically connected to the plurality of first pixel electrodes, respectively, and a plurality of second pixel circuits electrically connected to the plurality of the second pixel electrodes, respectively, each of the pixel circuits comprises a capacitor, and a capacitance value of the capacitor of each of the first pixel circuits is different from a capacitance value of the capacitor of each of the second pixel circuits;
a first power supply line configured to transmit a first power signal; and
a second power supply line configured to transmit a second power signal,
wherein the plurality of first pixel circuits comprise a first sub-common electrode and a second sub-common electrode, the first sub-common electrode comprises an area directly facing the plurality of first pixel electrodes, and the second sub-common electrode comprises an area directly facing the plurality of second pixel electrodes; and
wherein the first power signal transmitted by the first power supply line to the first sub-common electrode is different from the second power signal transmitted by the second power supply line to the second sub-common electrode.

2. The display panel of claim 1, wherein each of the pixel circuits comprises a driving transistor, one of a source and a drain of the driving transistor is electrically connected to a corresponding one of the pixel electrodes;
wherein the capacitor comprises a first capacitor, a first plate of the first capacitor is the one of the source and the drain of the driving transistor, and a second plate of the first capacitor is a gate of the driving transistor; and
wherein an area of the one of the source and the drain of the driving transistor in each of the first pixel circuits directly facing the gate thereof is different from an area of the one of the source and the drain of the driving transistor in each of the second pixel circuits directly facing the gate thereof.

3. The display panel of claim 2, wherein the pixel circuits comprise:
a first common electrode disposed in a same layer as the plurality of pixel electrodes; and
a second common electrode disposed opposite to the plurality of pixel electrodes and the first common electrode;
wherein the capacitor further comprises a second capacitor and a third capacitor, a first plate of the second capacitor and a first plate of the third capacitor both comprise the corresponding one of the pixel electrodes, a second plate of the second capacitor is the first common electrode, and a second plate of the third capacitor is the second common electrode; and
wherein an area of each of the first pixel electrodes directly facing the first common electrode is different from an area of each of the second pixel electrodes directly facing the first common electrode.

4. The display panel of claim 2, wherein the pixel circuits comprise:
a first common electrode disposed in a same layer as the plurality of pixel electrodes; and
a second common electrode disposed opposite to the plurality of pixel electrodes and the first common electrode;
wherein the capacitor further comprises a second capacitor and a third capacitor, a first plate of the second capacitor and a first plate of the third capacitor both comprise the corresponding one of the pixel electrodes, a second plate of the second capacitor is the first common electrode, and a second plate of the third capacitor is the second common electrode; and
wherein an area of each of the first pixel electrodes directly facing the second common electrode is different from an area of each of the second pixel electrodes directly facing the second common electrode.

5. The display panel of claim 2, wherein the pixel circuits comprise:
a first common electrode disposed in a same layer as the plurality of pixel electrodes; and
a second common electrode disposed opposite to the plurality of pixel electrodes and the first common electrode;
wherein the capacitor further comprises a second capacitor and a third capacitor, a first plate of the second capacitor and a first plate of the third capacitor both comprise the corresponding one of the pixel electrodes, a second plate of the second capacitor is the first common electrode, and a second plate of the third capacitor is the second common electrode; and
wherein an area of each of the first pixel electrodes directly facing the first common electrode is different from an area of each of the second pixel electrodes directly facing the first common electrode; and
an area of each of the first pixel electrodes directly facing the second common electrode is different from an area of each of the second pixel electrodes directly facing the second common electrode.

6. The display panel of claim 1, wherein the first sub-common electrodes are disposed opposite to the plurality of first pixel electrodes, and the second sub-common electrodes are disposed opposite to the plurality of second pixel electrodes.

7. The display panel of claim 6, wherein the pixel circuits further comprise a first common electrode disposed in a same layer as the plurality of pixel electrodes, a potential of each of the plurality of pixel electrodes alternates between being greater than potentials of the first sub-common electrodes and potentials of the second sub-common electrodes and being less than the potentials of the first sub-common electrodes and the potentials of the second sub-common electrodes in a plurality of frames; and
wherein the power supply lines alternately transmit a third power signal and a fourth power signal to the first common electrode in the plurality of frames.

8. The display panel of claim 1, further comprising:
a power manager configured to output the first power signal to the first power line; and
a signal processing circuit connected between the power manager and the second power supply line, and configured to generate the second power signal output to the second power supply line according to the first power signal.

9. The display panel of claim 1, wherein the plurality of sub-pixels comprise a plurality of first-color sub-pixels having the same color, and the display panel further comprises:
a plurality of data lines, wherein each of the data lines is electrically connected to corresponding ones of the plurality of pixel circuits, and is configured to transmit a plurality of data signals comprising a plurality of data voltages corresponding to the plurality of the sub-pixels; and
wherein when two of the plurality of first-color sub-pixels corresponding to one of the first pixel electrodes and one of the second pixel electrodes respectively have a same grayscale value at a same refresh rate, two data voltages of the plurality of data voltages corresponding to two data signals of the plurality of data signals corresponding to the two first-color sub-pixels are different.

10. The display panel of claim 9, further comprising:
a source driver comprising a gamma circuit for generating a first gamma binding point voltage and a second gamma binding point voltage, wherein the source driver is configured to generate one of the data signals as a first data signal according to a grayscale signal and the first gamma binding point voltage, and further configured to generate one of the data signals as a second data signal according to the grayscale signal and the second gamma binding point voltage; and
wherein each of the data lines electrically connected to corresponding ones of the first pixel circuits is configured to transmit the first data signal, and each of the data lines electrically connected to corresponding ones of the second pixel circuits is configured to transmit the second data signal.

11. The display panel of claim 10, wherein the first gamma binding point voltage comprises a first sub-gamma binding point voltage and a second sub-gamma binding point voltage, and the second gamma binding point voltage comprises a third sub-gamma binding point voltage and a fourth sub-gamma binding point voltage;
at a first refresh rate, the source driver is configured to generate the first data signal according to the grayscale signal and the first sub-gamma binding point voltage, and further configured to generate the second data signal according to the grayscale signal and the third sub-gamma binding point voltage; and
at a second refresh rate, the source driver is configured to generate the first data signal according to the grayscale signal and the second sub-gamma binding point voltage, and further configured to generate the second data signal according to the grayscale signal and the fourth sub-gamma binding point voltage.

12. A display device, comprising:
the display panel of claim 1; and
a housing for accommodating the display panel.
